(19) United States
(12) Patent Application Publication
(10) Pub. No.: US 2002/0194328 A1
(43) Pub. Date: Dec. 19, 2002

(54) Distributed, packet-based premises automation system

(76) Inventor: Peter D. Hallenbeck, Efland, NC (US)

Correspondence Address: STEVEN B. PHILLIPS, MORRE & VAN ALLEN, PLLC, 2200 WEST MAIN STREET, SUITE 800, Durham, NC, 27705, US

(21) Appl. No.: 10/068,157

(22) Filed: Feb. 6, 2002

Related U.S. Application Data
(60) Provisional application No. 60/298,313, filed on Jun. 14, 2001.

(51) Int. Cl. G06F 15/173; G06F 15/16

(52) U.S. Cl. 709/224; 709/249

(57) ABSTRACT

Distributed, packet-based premises automation system. The system can include, multiple, distributed, processor-based input/output (I/O) units. Changes in inputs can be broadcast using one or more protocols onto a home or other premises network, and/or the Internet. I/O units can receive commands from the network and effect control of the premises equipment based on those commands. Input and output identifiers have a format that allows them to uniquely identify any input and output in the distributed system, regardless of how large the system is or how many I/O units the system has. Any computer or controller on the network can see the changes in the inputs and any computer or controller can effect changes in an output, providing for true, distributed control. Virtual inputs are provided, each allowing a standard meaning to be applied to a storage bit that represents some state or condition of the premises.

### CROSS-REFERENCE TO RELATED APPLICATION

This application claims priority from co-pending provisional patent application serial No. 60/298,313 filed Jun. 14, 2001 by the inventor hereof, the entire disclosure of which is incorporated herein by reference.

### BACKGROUND

Since the invention of the microprocessor the dream of automating various parts of the home, business, or other building environment has been pursued. A variety of systems have been proposed or implemented by companies, trade associations, and individuals. However, despite high growth and the standardization of technologies such as the internet, personal computers, media storage, audio processing and video storage, premises automation technology has suffered from poor definition, and therefore limited growth.

While computer networks are now in wide use both in industry and the home, premises automation systems have not fully adopted a standardized form of networking for communication between all devices. Some known standards for low-level signaling have found acceptance, such as “X-10,” “1-Wire,” and “CE Bus.” However, a problem with computer networks used in premises automation results from the fact that they are used primarily to model direct wired connections between sensors, actuators, and a control computer. Interoperability and expandability is limited, and typically, a system must be customized extensively for each home or office environment.

Another problem with most systems is that many premises automation functions are exercised by a centralized controller with a microprocessor that handles all of the automating tasks. The concept of a distributed system utilizing a home network has not been fully applied. The reliability of today's systems depends on the reliability of the central controller, and any change in the number or type of devices being controlled or providing input necessitates reprogramming the central controller. Furthermore the programmer or software developer responsible for the controller in many cases needs detailed knowledge of the configuration of the premises involved.

### SUMMARY

The present invention provides for a premises automation system that is truly distributed in nature, resulting in enhanced reliability and expandability. The system can include, multiple, distributed input/output (I/O) units. An input to the system can be an actual physical input, an internal stored variable or semaphore, or a virtual input, which corresponds to a logical relationship between other inputs, variables, or semaphores. Changes in inputs can be broadcast using one or more protocols onto a home network, and/or the Internet. I/O units can receive commands from the network and effect control of the premises based on those commands. Any computer or controller on the network can see the changes in the inputs and any computer or controller can effect changes in an output, because inputs and outputs are referred to in all protocols using a scheme of input and output identifiers that is known to all devices. These input and output identifiers uniquely identify any input and output in the distributed system, regardless of how large the system is or how many I/O units the system has.

The invention is implemented through various methods, data structures and apparatus. In one embodiment, an input event is detected by reference to a scan table stored in memory specifying the event in association with an input identifier. An action is performed based on a description of the action which is stored in the scan table in association with the input event and the input identifier. If necessary, internal variables are updated. The action taken may include the sending of a packet, either broadcast, or directed to specific node, on a network wherein the packet is formatted to communicate the occurrence of the event. Input and output identifiers may be included in the packet. Input and output identifiers, either in packets, or in scan tables or data structures, are of a format that allow them to designate or specify any input or output from among distributed inputs and outputs in the system.

If the input event as discussed above is a premises related event, that is, an event that is related to a real change in the state of the premises as detected by a sensor or by automated equipment, it may be imperative that some action is taken. In such cases, the responsible I/O unit can, after sending a notification packet, set a timer, which is associated with an input. If the timer counts down indicating that a pre-determined amount of time has elapsed prior to receiving a response, a default action, which is specified in a scan table or data structure, is taken. The ability of an I/O unit according to the invention to intervene if a controller, soft ware process, or computer does not respond as expected enhances the reliability of the premises automation system.

An I/O unit according to the invention, can receive a packet that is formatted to direct a change in a state of the output. If the output is connected to premises-based apparatus, such as a heating system, appliance, or security system, the change in state of the output might be effected to communicate with the premises-based apparatus. The packet uniquely identifies the output with an output identifier, and also communicates the change in state. The same type of packet can also be used to modify internal variables, clear semaphores and perform other, similar functions. Such packets can be originated from various processor-controlled apparatus, including input devices (keypads for example), controllers, and personal computers and workstations. The processor, memory, and program code in such apparatus serves as the means for sending these packets to the system.

Various data structures stored in machine readable memory, are used to enable embodiments of the invention. In some cases it is useful to think of these data structures as tables of information that are scanned by a processor and so these data structures are sometimes referred to as scan tables. For example, the data structure that directs the response to an input event includes a plurality of input identifiers with associated event descriptions. Each input identifier has at least one associated event description. At least one action description is associated with each input event description. If the action includes sending a notification packet, a second data structure may contain a timer value or other variables that that are updated enable a default action if no response to the notification packet is received. The default action may be changing an output, either directly or by sending a packet to another device.

Another data structure serves as a means for providing for a “virtual input” when combined with appropriate processing hardware or software. The structure includes a description of a logical relationship, and a plurality of entries to which the logical relationship applies. Each entry produces a Boolean result on which the logical relationship operates to produce the virtual input. A storage bit stored in memory indicates the state of the virtual input. Each entry in the data structure includes at least an input identifier serving as a first operand, an operator, and a second operand. The provision of a virtual input with such a structure is herein called “input aliasing” and allows a standard meaning to be applied to a virtual input that represents some state of the premises, such as whether any outside doors are open.

An I/O unit according to the invention includes a processor for controlling the operation of the unit, and a plurality of local inputs and outputs operatively connected to the processor. The inputs and outputs can send and receive data or control signals in various formats, but at least some of the local inputs and outputs are typically operable to communicate with premises-based apparatus. The unit also includes at least one network connection, and a memory encoded with program code to enable the processor to control the operation of the unit. The “memory” is typically some form of semiconductor memory, but can also be a media device, a network file system, a database, or a network database, or a combination thereof. The hardware and program code inside the I/O units in premises automation system form the means to carry out various aspects of the invention.

### BRIEF DESCRIPTION OF THE DRAWINGS

FIG. 1 is a network diagram of a premises automation system according to an embodiment of the invention.

FIG. 2 illustrates a variable definition table, a type of data structure that is used with one embodiment of the invention.

FIG. 3 shows an “input scan table” data structure that is used with some embodiments of the invention.

FIG. 4 shows a configuration scan table that can be used with the invention.

FIG. 5 shows an “output scan table” data structure that is used with some embodiments of the invention.

FIG. 6 illustrates both the data structure and flow aspects of the input aliasing mechanism that is used in some embodiments of the invention.

FIG. 7 illustrates the format of an output packet according to some embodiments of the invention.

FIG. 8 is a flowchart that illustrates some aspects of the invention.

FIG. 9 is a flowchart that illustrates further aspects of the invention.

FIG. 10 is a flowchart that illustrates additional aspects of the invention.

FIG. 11 is a flowchart that illustrates additional aspects of the invention.

FIG. 12 is a hardware block diagram of an example I/O unit according to the invention.

FIG. 13 is a hardware block diagram of an example processor-based device that can be used with the system of the invention for sending output packets like that shown in FIG. 7.

FIG. 14 is a block diagram of a programmed personal computer system or workstation, which can send output packets like that illustrated in FIG. 7.

### DETAILED DESCRIPTION OF ONE OR MORE EMBODIMENTS

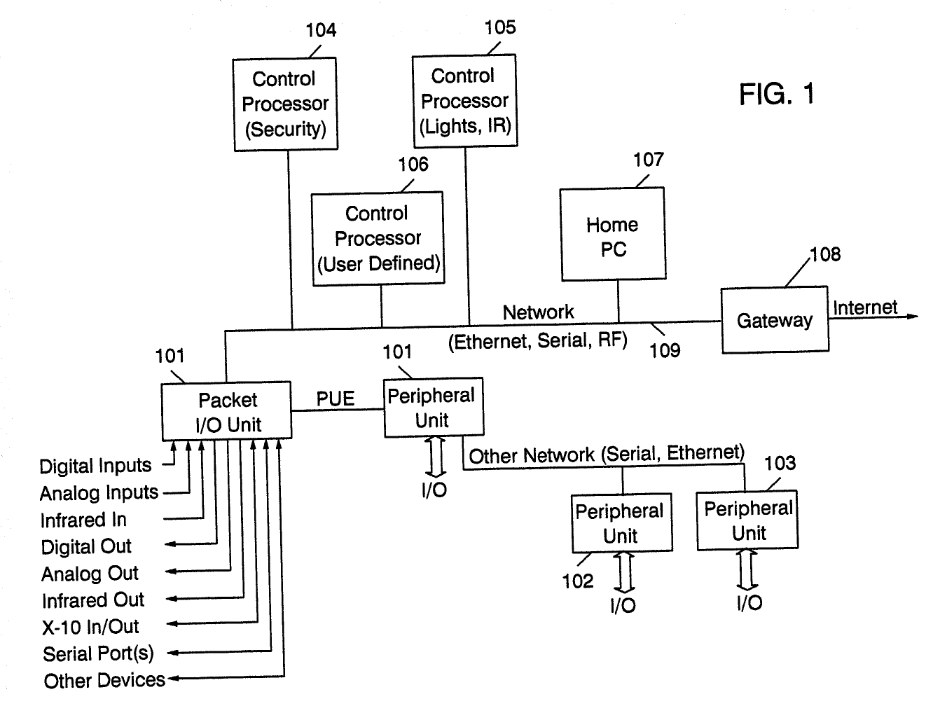

FIG. 1 is a network level block diagram showing a premises automation system according to the invention. The system of FIG. 1 is fairly large; however, it is shown by way of example only. A system incorporating the invention can be much smaller, even consisting of one I/O unit. This system is comprised of multiple I/O units, 100, 101, 102, and 103. An example of the connective topology, used by this example implementation, is packet I/O unit 100 that is connected to a home network including control processor or software program 104 for a security system, control processor or software program 105 which provides lighting and infrared device control, and control processor or software program 106, which is user-defined. A home personal computer, 107, and Internet gateway 108 can also be connected to this network, and are shown in this example. The home network, 109, is often an Ethernet, but can also be a radio frequency (RF) wireless network, a serial network, or any other type of network. The gateway to the Internet, 108 of FIG. 1 is included for facilitating transmission of Email or other types of messages or packets over the Internet if a notification of an event needs to be communicated outside the premises.

The additional I/O units are connected to unit 100 via a specialized type of serial port on units 100 and 101, which is called herein a “peripheral unit expansion” (PUE) interface, to be described in detail later. The PUE electrical interface in the example embodiments shown is similar to an “RS-485” port, but may take other forms. Additional units 102 and 103 are connected to unit 101 through a second home network in this example, although they could also be connected through the PUE interface. Units connected through the PUE interface are typically smaller in size, cost, and capability, and are thus referred to as “peripheral I/O units” or simply “peripheral units,” not to be confused with the term “peripheral” as applied to computer peripherals. The serial type PUE interface is slower than many types of network connections, such as Ethernet, but this slower speed is acceptable because of the smaller data bandwidths of the peripheral units.

Each I/O unit has a number of different devices that can connect to it's inputs and outputs. Some devices, such as switches and relay contact closures, require little processing. Others, such as analog voltages that represent temperatures, will require a little more processing. And some, such as serial ports and infrared I/O will require still more processing. Some of these inputs and outputs are illustrated in FIG. 1 as connected to packet I/O unit 100. These include digital inputs and outputs, analog inputs and outputs, infrared inputs and outputs, X-10 ports, and serial ports. The peripheral I/O units have similar types of I/O, but specific inputs and outputs are not shown for clarity.

At this point, it is useful to discuss the input and output identifier system or addressing scheme. This scheme enables inputs and outputs throughout the premises automation system to be treated as a large collection of what is referred to herein as distributed inputs and outputs, meaning inputs and outputs that are spread across multiple I/O units. Each I/O unit in the system has a unique unit number so that all the I/O in the system can be uniquely addressed. Furthermore each input on an I/O unit with a particular unit number has a unique input number within that I/O unit. Likewise, each output on an I/O unit with a particular unit number has a unique output number within that I/O unit. In this way, an input can be addressed with a combination of unit number/input number, and an output can be addressed with a combination unit number/output number. Thus, all “things” manipulated by the system have a unique identifier. The unique identifier has a format that consists of at least two pieces, a unit number and an input/output number. The unit number is used much like a subnet mask in Internet protocol during routing. It assists in the routing of packets to I/O units. One or more I/O units will typically contain routing tables making use of the unit number, so that an I/O unit can determine which interface (Ethernet, serial, etc.) to forward a packet over if the packet is destined for another I/O unit. The input/output number refers to the “thing” being manipulated, be it a physical input, physical output, or internal variable, as discussed below. These numbers are unique system wide. The control of a collection of units can be executed via multiple pieces of software that may reside on multiple processing platforms and that use these unique numbers. It should be noted that the implementation of the inventive concepts discussed herein is not limited to the specific format for the unique identifiers disclosed. All that is required is that the format allow an input or output to be distinguished within plurality of distributed inputs or outputs, as the case may be. The identifier can also contain more information than just a unit number and input or output number.

With FIG. 1 and the discussion of input and output addressing in mind, various definitions as used in this disclosure can be discussed. The word “input” is used to refer to anything that can provide a value for an equation or computation or other function. Of course, physical inputs are inputs. Internal variables are also provided. These are stored in memory and can be manipulated and used for computations. An internal variable can be as simple as a storage bit that can take one of two values, 0 and 1. Any internal variables that have been assigned unique identifiers in accordance with the identifier scheme discussed are special inputs, which are referred to herein as “internal inputs.” Even physical outputs can be treated as inputs because their current state can be read back and used in the making of decisions. A specific type of internal input is referred to as a “virtual input.” Virtual inputs represent physical status information of the premises that cannot be simply represented by a single physical input. They are managed by an input aliasing scheme to be fully discussed later. The word “output” is used to refer to anything than can accept a value or values from a packet or internally driven decision result. Physical inputs cannot be outputs. Internal variables can be outputs if their value can be set. And of course, physical outputs are outputs.

All the inputs, outputs, and variables that are manipulated in the system are objects more than they are simple bytes or bits. The concept of a “type” is used to classify these objects. For example, the “type” of form “digital input” refers to a physical, single bit input into an I/O unit. An internal variable has a type just like a physical entity. Inputs, both internal and external, can have associated variables, which are also uniquely identified by the input identifier and their type. The software for a unit creates whatever internal variables are needed. The software in the packet I/O units refers to data structures stored in memory to make decisions. These data structures can also be referred to as decision tables or scan tables. When parsing and evaluating decision tables, a unit's software takes a unique identifier and determines what object is being addressed, be it a physical input, output, or internal variable, and then returns or sets it's value.

All of the I/O units, or simply “units” shown in FIG. 1 contain I/O, at least in the example embodiments disclosed. As previously discussed, there are two kinds of I/O units shown. The larger unit with more processing power is referred to herein as a “packet I/O unit” whereas each of the smaller units is referred to herein as a “peripheral I/O unit” or a “peripheral unit”. In practice, the packet I/O unit might be thought of as a “basement box” which might reside together with or inside central wiring cabinets, where as the peripheral units would be scattered about the premises. In the specific example embodiments disclosed herein, either or both might contain internal variables and/or input aliasing mechanisms and the data structures that define these; however, only the larger packet I/O unit would typically include the decision table structures to be discussed in detail below. Of course, a system could be devised where there is more than one packet I/O unit on a premises able to communicate with each other, each being connected to peripheral I/O units.

The word “semaphore” refers to an associated variable of a type. It might also be called a “flag”. It is a bit value. While an internal storage bit variable may be used generically as a semaphore by the software, it is called a storage bit so as not to be confused with the associated variable “semaphore”. In addition to being associated with an input, semaphores, at least in one embodiment of the invention are atomic, where as storage bits are not. Semaphores are referred to as atomic because when a task running in an I/O unit accesses a semaphore, no other tasks can access it until the first task is complete allowing for atomic read-modify-write access.

The word “timer” refers to an associated variable which is an entity (typically 16 bits) that counts down monotonically to zero with time and remains or “sticks” at a value of zero until reset. In some embodiments, there is also an internal input called a “timer_count” which behaves the same way, and has it's own associated variables of a semaphore and timer. In software terminology, all names of structures (types) and their elements (associated variables) have unique names. The ability to provide unique names for everything in a system with multiple I/O units provides in part for the distributed nature of a premises automation system according to the invention.

For convenience, several other terms are used generally to refer to events and equipment that affect a premises automation system according to the invention. An “input event” is a change in state at, the setting of, or reception of information or data at an input, be it physical, or internal. A “local input” or “local output” is an input or an output at an I/O unit presently being discussed. Distributed inputs or outputs are those that are spread across the premises automation system, and include local inputs and outputs, and remote inputs and outputs, which are those on other I/O units. Premises-based apparatus is any physical equipment that connects with the I/O units, other than other, independent I/O units. Premises-based apparatus, however, could be physically combined with an I/O unit. Examples of premises-based apparatus include personal computers, Internet gateways, security, HVAC, or lighting controllers, and even sensors, switches, keypads, and the like. Note that some devices might connect either directly to a packet I/O unit, or be connected through another controller depending on how the user or installer designed the system. Thus, to use lighting as an example, either a lighting controller, or a remotely activated light switch by itself can be “premises-based apparatus. A premises-based event is an input event that results from communication from premises-based apparatus, and is often a real, physical event that is sensed at a physical input.

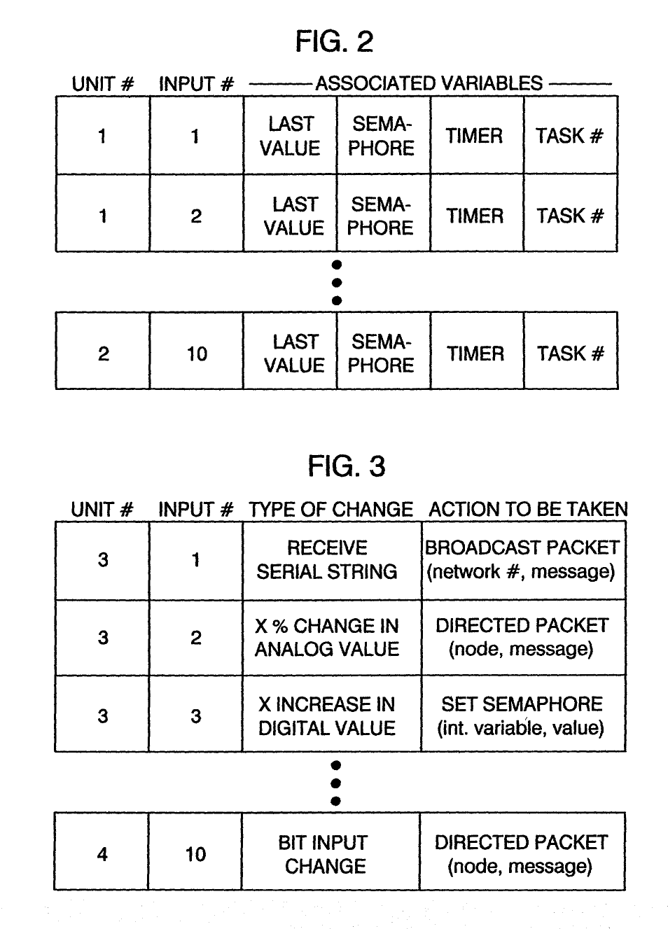

FIG. 2 is a more detailed look at the elements in the object for a type whose class is input. FIG. 2 is illustrated as a table and can be thought of as a data structure. Elsewhere herein it is referred to as an input definition table. Inputs shown in FIG. 2 correspond to both physical and internal inputs. Physical inputs represent real, physical samples or measurements. These measurements may have been processed by software on an I/O unit. Such processing could remove some of the details of the physical device, or provide for correction of values based on calibration data entered for an individual sensor. Other examples include the extraction of a data field from a serial protocol, or the conversion of an infrared (IR) stream into a specific key press event. Internal inputs either mimic physical inputs or are representative of data that is typically stored on a microprocessor.

Each unique input identifier consists in this example of the unit number and input number, shown in the columns labeled “UNIT #” and “INPUT #” respectively. For each input identifier, there are associated variables that exist. In the example of FIG. 2, the sections of the table shown illustrate digital inputs, or internal inputs that mimic digital inputs. Those shown are Inputs 1 and 2 of Unit 1, and Input 10 of Unit 2. Associated variables for a digital input include its last value, used to determine if the input has changed and a semaphore that can be set by a scan of a decision table data structure (explained later). There is a timer, which can be set. The timer variable has a value written into it. The timer variable decrements monotonically with time, with a constant period of time between decrements, until it reaches a value of zero. Once the timer reaches zero, it is not decremented any more. A timer that is non-linearly decremented could also be used. For example, a timer could be decremented logarithmically, or in a table-driven fashion. There is also a task number. The task number allows the unit to activate a task (or program) which knows how to deal with the input. For example, when an IR bitstream transitions, a timer can be started. When the timer reaches zero, a task that knows how to interpret the IR stream could be notified. The task would examine the raw IR stream and then determine which key on the remote control was pressed. All of these examples are shown in FIG. 2 in the columns labeled “ASSOCIATED VARIABLES.” There are different types of associated variables for other types of inputs, and the table can be much larger than the example here. Note that a table stored in a packet I/O unit, can define inputs in other I/O units. Assuming this table is stored in Unit 1, it can be observed that the last entry in this table identifies an input in Unit 2. It should be noted that the fields for associated variable shown in FIG. 2 are optional, and are shown here merely as part of the illustrative embodiment being described.

FIG. 3 illustrates a data structure which is called an input scan table or input decision table. The purpose of the entries in the table is as follows. Periodically, a program on a packet I/O unit scans the table in a first entry to last entry basis, and performs a test based on information in an entry to see if there has been a change in an input. The program may need to refer to the input definition table to determine when there has been a change. If the input has changed, then the specified type of action is taken, again based on items stored in the entry in the list. If the scan order of the list is in a specific sequence, such as first to last, there are some advantages in the software knowing that the test for the indicated types of changes are done in a specific order. In particular, it is possible to test for a condition and set some variable, and then later on when going through the list, that result can itself be used as part of a test. If the scan is done in a non-specified order (say, one where other mechanisms caused the list to be scanned in a random or event driven fashion), this advantage is lost but the structure still performs it's intended function. A specified order of scanning the table also provides for the concept of priority. When an input or event could result in more than one action, a priority can be established regarding which action should be taken first. The columns of data in the table give the unique input identifier, including a UNIT # and INPUT # as before. Each input in this table also has a type, such as digital, analog, etc. The type is not shown in FIG. 3. In the example embodiment described here, it is stored once in a separate look-up file to be described later, but it can be added to this scan table instead.

The next column of data in an entry is a specification of the TYPE OF CHANGE that the input has to have seen in order to have a specified action occur. The exact manner in which the type of change that has occurred is determined is dependent on what type the data is. The number of comparisons that can occur is predetermined by an I/O unit's software, which has specific and unique codes for each type of comparisons. Each type has certain operators that it supports, which may be unary or binary in nature, and may or may not have addition arguments.

The last column of data is the ACTION TO BE TAKEN if it is determined that the specified input has changed as specified. There are a variety of packet-based actions which can be taken, representing all the different physical means and protocols than can be used by the packet I/O unit to communicate with one or more programs or processors on the network. It is also possible to take actions on internal variables, these actions being primarily assignment of values to other variables. These variables include both actual internal variables and the associated variables of any input identifier. Thus, following the example of FIG. 3, if a certain serial string is received at Input 1 of Unit 3, a broadcast packet is sent. If a certain percent change in the analog value at Input 2 of Unit 3 is recorded, a directed packet to a specific address is sent. If a digital value decreases a specified amount at Input 3 of Unit 3, a semaphore (an associated variable of some input) is set. Finally, a bit input change at Input 10 of Unit 4 again results in a directed packet.

It is a software implementation decision as to how many actions are allowed in an entry in the scan table data structure. In this example, there is only one, and if multiple actions are to be taken (such as sending a uniform data protocol packet, sending an Email, and setting a timer) there are multiple entries with identical input identifiers and TYPE OF CHANGE descriptions. It should be noted that in the example embodiment of FIG. 1, the input scan table is only present in the packet I/O unit, which processes inputs for itself and its associated peripheral units, as though each peripheral unit was an extension of the packet I/O unit. Thus, it can be assumed for purposes of these example embodiments that any unit numbers not corresponding to the packet I/O unit containing the table correspond to peripheral I/O units. However, the invention is not limited to this architecture. It would almost certainly be possible to devise a system in which peripheral units contained decision scan tables.

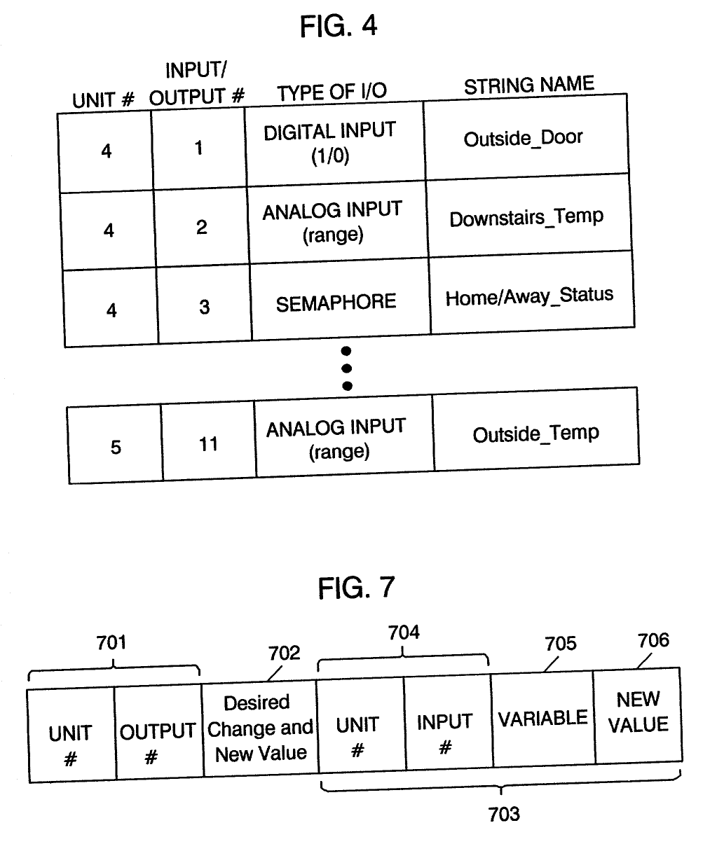

FIG. 4 illustrates the concept of including in an I/O unit a file or files which includes a table in which each entry has multiple fields. In this embodiment, each entry has three fields. The first field is the input or output identifier, as before. The second field is the type of the input or output of an entry, with samples of the types shown on in the column under “TYPE OF I/O.” This is where types can be stored once for use throughout the system, including when decisions are made based on the input scan table previously discussed. Note that the type field could be omitted if the type were always stored with the identifier. The types of inputs shown in FIG. 4 are, respectively, a digital input, an analog input that can take on a specific range of values, a semaphore, and another analog input.

An optional third field in each entry is shown under the STRING NAME column, an alphanumeric string identifier for the input. In one embodiment of the invention, a similar table or file exists for inputs and outputs, although, these could be combined into one file with appropriate additional fields. The alphanumeric character strings provide the ability for outside systems or maintenance personnel to discover information about the inputs and outputs in the system electronically. A designers or installer of a system will presumably store in the file intelligent names that help explain the precise function, location, and type of an input. As such, it is not necessary to have cumbersome numeric tables. Maintenance and debugging time for a premises automation system is reduced using a file of this sort, because, for example, Input 1 on Unit 4 represents that an outside door is open. Likewise, it is known that Input 2 on Unit 4 receives temperature readings for the downstairs, and Input 11 on Unit 5 receives outside temperature readings. In this example, an internal variable serves as an internal input, Input 3 of Unit 4, representing the home or away status of a house. The file of FIG. 4 can be created locally via a local connection (serial port) with software resident on the unit, or the Internet via a file transfer mechanism such as the file transfer protocol or secure file transfer protocol (FTP or SFTP).

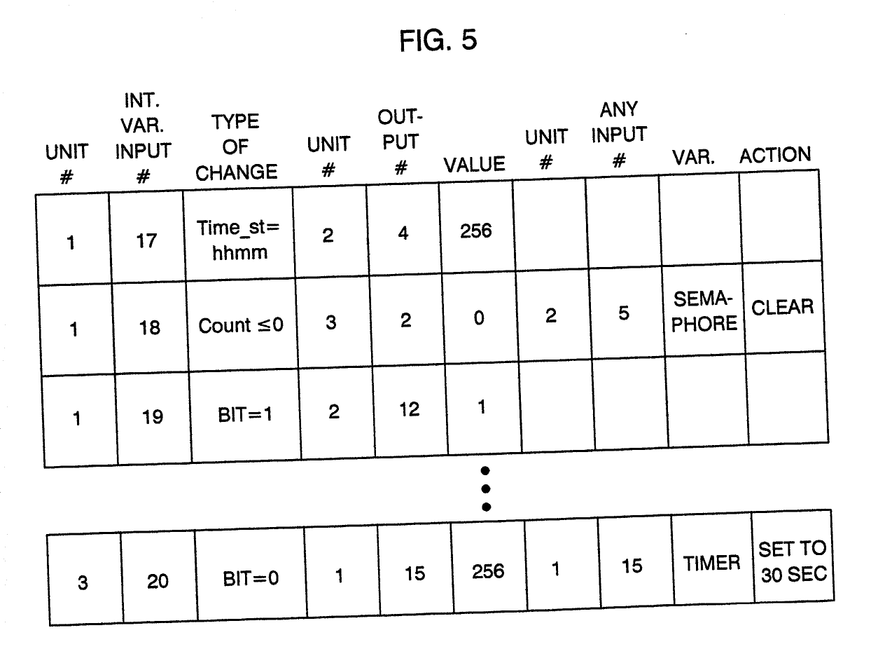

FIG. 5 introduces a data structure herein referred to as an output scan table or output decision table. The decision process implemented by this structure is similar to the process discussed with respect to FIG. 3, and in fact may be implemented by the same body of software. In this embodiment, the unique input identifier shown in the first two columns always refers to an internal input, although this internal input can be an internal variable that is an associated variable of a physical input. The purpose of this scan table, in part, is to specify output changes based on changes in internal inputs. In this embodiment, a physical input never directly affects a physical output. This is important to maintaining the distributed nature of a premises automation system according to the invention. Changes to physical inputs must always be seen by processors on the network, outside of the I/O units, without being acted on, at least initially, by any I/O unit. It should be noted that systems which use some elements of the invention and some elements of a more traditional, centralized processor-based automation system could be devised. In such a case, at least some outputs could not be changed directly through a change at an input.

The next field in each entry is shown in the column labeled “TYPE OF CHANGE” and is the type of variable change being tested. As with the input scan table of FIG. 3, the comparison made and operator used is dependent on the type of input. There can optionally be two checks done instead of just one. The next columns specify the output action to take if the indicated type of change has occurred. Recalling that an output identifier refers to anything that can be written including both physical outputs and any settable internal variable, therefore the output action can effect real changes or just change variables. The “UNIT #” and “OUTPUT #” columns form an output identifier for each entry. The next field, labeled “VALUE” in FIG. 5 gives the value that is to be stored in or sent by the output.

There are also optional fields shown in FIG. 5 for changing a specified input's associated variables. These inputs can be physical or internal. These optional fields are shown in the third column to be labeled “UNIT #” that is for an input identifier, and in the columns labeled “ANY INPUT #”, “VAR.” for the associated variable, and “ACTION” which describes how to change the associated variable. In a manner similar to the input scan table, the entries in the output scan table are processed one after another. If the type of change has occurred, the specified output action occurs. The order of processing could be random, but again if the order is specified there are certain advantages with regard to factoring complex output actions and establishing priorities of execution. As before, there could be additional fields to specify compound actions. Also, as before, the output scan table would typically, though not necessarily, be resident only on a packet I/O unit, and not on any peripheral units.

The entries shown in FIG. 5, from top to bottom, direct the premises automation system as follows. In the first entry, when a time string at input 17 of unit 1 reaches a certain value (at a specific time of day), output 4 of unit 2 is set to a value of “256.” In the second entry, if a counter that serves as input 18 of unit 1 reads zero (or negative), output 2 of unit 3 is set to 0, and the semaphore associated variable at input 5 of unit 2 is cleared. In the third entry, if bit input 19 on unit 1 is “1” then output 12 of unit 2 is also set to “1.” Finally, if bit input 20 on unit 3 is a “0” then output 15 on unit 1 is set to a value of “256,” and a timer associated variable of that same input, input 15 of unit 1, is set to 30 seconds.

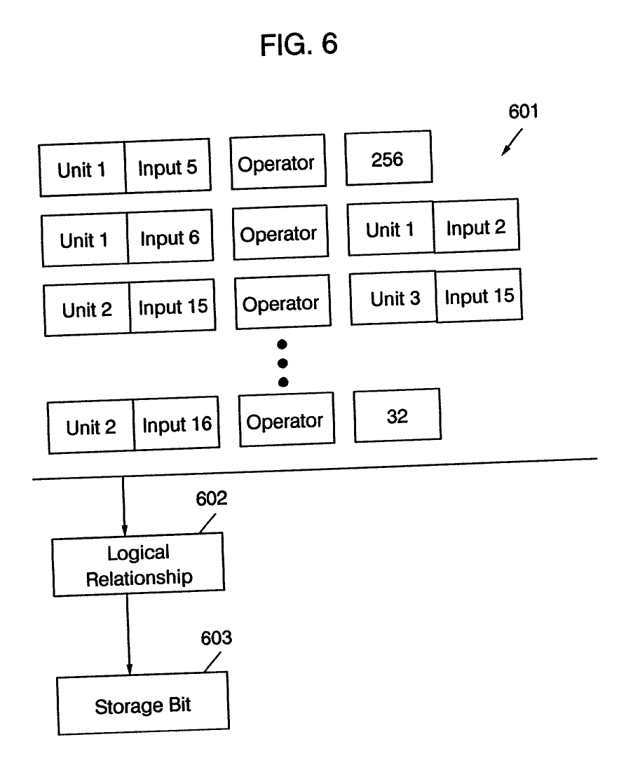

FIG. 6 illustrates an example of the previously mentioned “input aliasing” mechanism that generates a special type of internal variable called a “virtual input.” This mechanism might be used, for example, to take single bit, physical inputs that represent the status of each of the outside doors in a home, as determined from magnetic reed switches on the doors, and combine them into one virtual input which represents whether any outside door is open. This functionality is achieved via a number of variable length entries, 601, in a table, which is part of the data structure that implements this feature in some embodiments of the invention. Each entry has at least one, and up to some finite number (bounded by the processor constraints of memory and speed) of entries. Each entry consists of a unique input identifier, which serves as the first operand in the entry, an operator, which can have object-oriented properties, and a second operand which can be either another unique identifier or a fixed value.

The entries in table 601 are all evaluated, producing a Boolean result of one or zero (or “True or False”) for each. Then, all the results are combined using a logical relationship specified and stored at 602. Typical logical relationships are “All are True”, “Any is True”, and “None are True.” Other logical relationships, embodying concepts like “most are true” can be added as needed. The end result of the entire list of entries is a single Boolean outcome, which is the virtual input, and which is stored at storage bit 603. If the resultant single Boolean outcome is true, then a variable designated by a unique output identifier can be directly modified. Specifically, the identifier can be of a type of storage bit or semaphore associated with an internal variable. The bit can be set, toggled or cleared.

Note that this aliasing mechanism is a more complex set of logical relationships than those supported solely by the decision table structures previously discussed. Note also that the result is a single bit, which potentially changes if any of the operands in table 601 change. Note also again that outputs are not changed with this mechanism in the embodiment described here, for the same reasons as previously discussed in connection with physical inputs and physical outputs. The order in which the table entries are evaluated could be random. If the entries are evaluated in a specified order, however, some benefits are realized. For example, if the order is from first entry to last, then the software, which creates table 601 can take into account compound and complex expressions with specific precedences (such as parenthetical expressions). A “higher priority” can be placed on relationships “inside the parenthesis” and internal variables of a temporary nature can be initially set, followed by computing the remainder of the expression. Such a “compiling” phase of creating this table, analogous to a C-language compiler analyzing an expression and producing a linear set of computations in the correct order, allows the aliasing mechanism to handle very complex “IF” type statements. In this embodiment, there is no “THEN” function or field in this mechanism. All that can be done is to note the outcome of an “IF”. Once the internal variable is set, other pieces of the system, most notably the decision table structures previously discussed, can detect a change and then effect an action. An input aliasing mechanism in this example embodiment could be present on the packet I/O unit, on one or more peripheral units, or on both.

In the specific example of FIG. 6, the value at input 5 of unit 1 is combined with the fixed value “256” according to an operator. The value at input 6 of unit 1 is combined with the value at input 2 of unit 1 according to an operator. The value at input 15 of unit 2 is combined with the value at input 15 of unit 3 according to an operator. Finally, the value at input 16 of unit 2 is combined with a fixed value of “32.” Although the operators can have object-oriented properties, they can be as simple as “=”, “<”, “>” and the like. An additional “action to be taken” field can be added to the input aliasing mechanism. Adding this field is simply a convenience and avoids an entry in the decision scan table data structures. One could add multiple action fields to optimize the table based on knowledge of a specific type of configuration that is found frequently enough to warrant additional action fields.

FIG. 7 illustrates the format for packets received by an I/O unit for the purpose of effecting a change in an output in an example embodiment of the invention. The packet has a unique output identifier, 701, that has a specific type. Field 702 contains instructions for the desired change for the output specified by the unit number and output number in field 701. The change can be applied to physical outputs, or internal variables, if the internal variables are assigned a unique output identifier. Field 703 can include instructions to change an associated variable for an output if associated variables are allocated to an output, since the type designations are consistent for inputs and outputs.

In setting a variable, one can set a parameter for a software program resident on the I/O unit, such as a desired temperature for a room. Software on the I/O unit may then control a variety of outputs, and sample a variety of inputs to achieve the temperature setting. A task can be enabled for running, or disabled from running. In this fashion, tasks may be stopped, variables for the task set, and then the task can be enabled for running again. This is the inverse situation to that in which inputs are scaled, adjusted for calibration factors, and processed in software prior to the value being read for processing by the main I/O unit architecture (such as an analog input being sampled to reduce noise). An I/O unit according to the example embodiments of the invention communicates with the various controlling tasks being executed within it in specific data types. The unit is responsible for translating, adjusting or controlling the actual inputs and outputs to achieve this communication. In much the same way that a computer on a network passes an IP packet to the lower layers in an open system interconnect (OSI) model, an I/O unit according to the invention can take the variety of different sensors, output relays, inputs, and the like, and create hardware independent values associated with each type.

The output packet command format as shown in FIG. 7 provides for an optional ability to change the associated variables of a specified input. Optional fields 703 include a unique input identifier 704, as well as the name of the variable, 705, and a new value to which to set the variable, 706. Fields for multiple variables can be added. Note that two packets could have been sent: one to effect the output and one to modify the associated variables of an input. For reasons of network efficiency to simplified timing constraints on managing semaphores, the illustrated format allows both outputs and input variables to be specified in the same packet. A system would most likely be designed so that output packets are received and processed by a packet I/O unit. In this case, the packet I/O unit might direct the setting of an output on a peripheral I/O unit. But, a system could be designed so that other I/O units could also receive and process output packets directly.

With the above descriptions of the overall system architecture and data structures in mind, the software which runs in each I/O unit to operate the unit and manage tasks can be described. In the example embodiments shown in this disclosure, software in a unit resides in electronic memory, that is, a combination of types of read-only memory (ROM) and random access memory (RAM). Other types of memory devices can be used. For example, a fixed disc drive or optical memory device could be included in some or all of the units. In any case, each unit includes an operating system. The operating system in this example embodiment is a non-preemptive, multitasking operating system with good real time characteristics. The operating system architecture should allow a response time to events in the millisecond range. Other operating systems, or a large, single control program can be used.

If no media devices are used in the operating system, the operating system does not require any file system. All that is required is I/O functions and scheduling. Each task running in the operating system is responsible for establishing the conditions under which it can be run. Therefore, each task controls its own scheduling. Scheduling is performed by the task, not the operating system. Scheduling is non-preemptive and system calls are made to access registers and I/O. In the example embodiments shown in this disclosure, the operating system software resides in flash ROM. The operating system can be written and updated on a personal computer or workstation. The personal computer or workstation can interface to an I/O unit in diagnostic mode via a serial port, network, or other suitable interface.

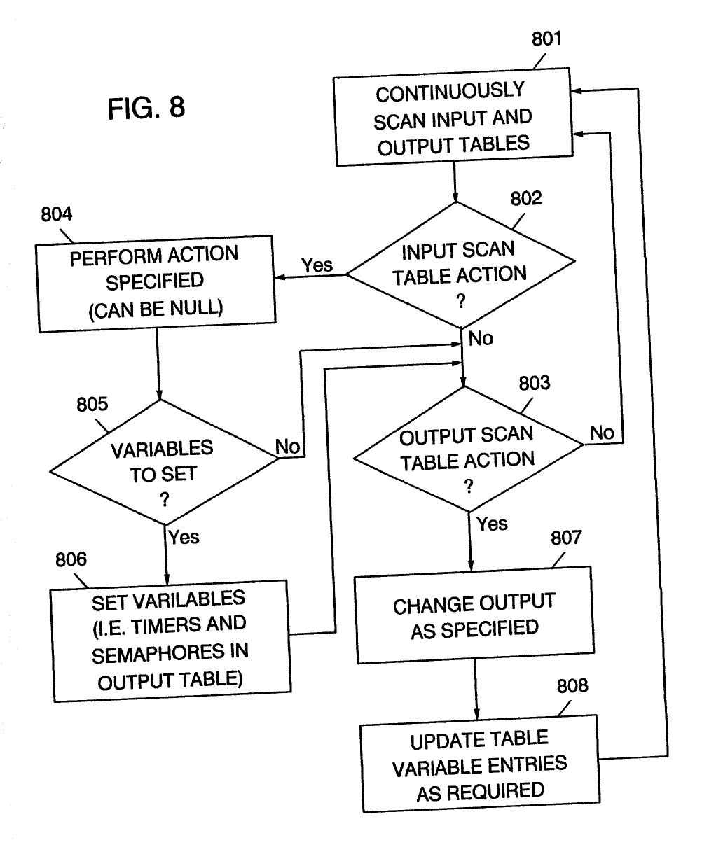

FIGS. 8 through 12 illustrate many of the software processes implemented by a combination of operating system and task software running in a premises automation system according to an embodiment of the invention. FIG. 8 is flow chart that illustrates the process of scanning decision tables and responding to events using the previously described data structures. At step 801, a packet I/O unit is initialized and begins to continuously scan input and output scan tables. If an input scan table action is detected, it is detected at 802. If an output scan table action is detected, it is detected at 803. If neither is detected, the tables are scanned until an event occurs. In case of an input scan table action, the action specified in the table is performed at step 804. It should be noted that this action could be “no action” otherwise known as a null. For example, this might be the case if the table entry was inserted simply to set internal variables. In any case, the packet I/O unit involved makes a determination based on the table entries as to whether internal variables need to be set at step 805. If so, the variables are set at step 806. As previously discussed, these variables might include timers and semaphores in the output scan table. If an output scan table action is detected at step 803, the appropriate output is set at step 807. In this case, it may also be necessary to update variables in one or both of the tables. This update occurs at step 808. Processing continues with the further scanning of the tables until another change is detected that requires action.

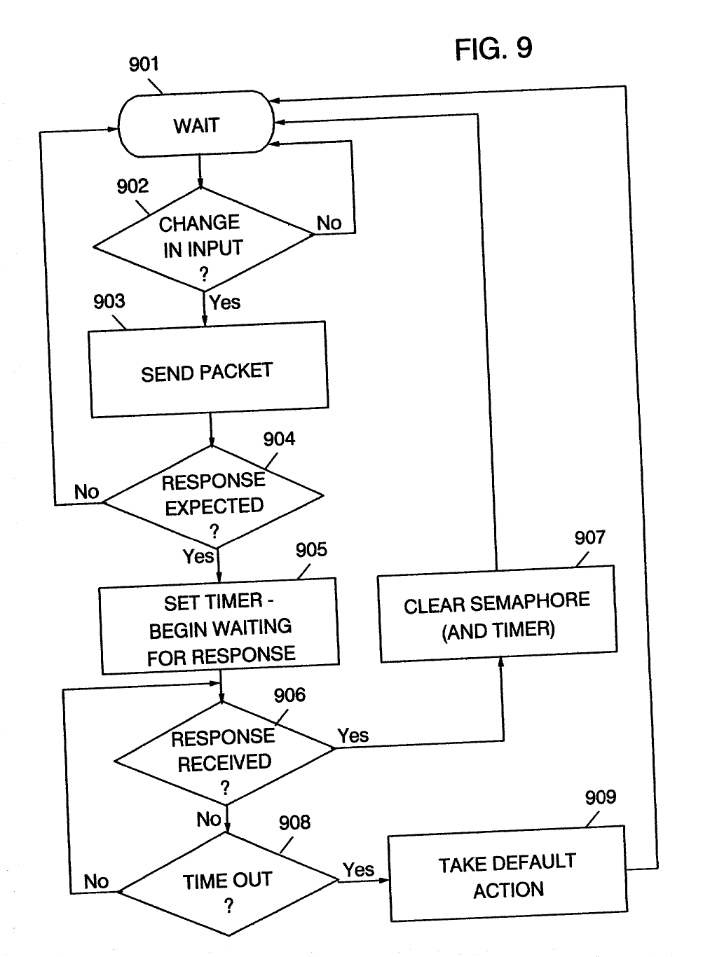

There is a useful algorithm that can be implemented with the process of FIG. 8 and the data structures previously discussed. This algorithm is illustrated in FIG. 9. While in this example, the algorithm is implemented with the data structures illustrated in this disclosure, the same algorithm could be implemented by other means, in premises automation systems that work on different principles than those discussed in this disclosure. At 901 a packet I/O unit according to the invention or other premises automation device is waiting and as of yet has not detected any changes. At step 902 a change in an input occurs. At step 903 a packet is sent over the network in response to the event. With the system of the invention, this packet would most likely be a broadcast uniform datagram protocol (UDP) packet to all units on an Ethernet network. Depending on the particular system design, however, other types of packets or communication messages could be sent as a response. In the particular embodiment of the invention that has been illustrated, the sending of this packet would be dictated by the input scan table. At step 904 a determination is made as to whether a reply to the packet is expected. If so, at step 905 a timer is set. If the particular embodiments previously described are employed, the timer and semaphore variables specified in an input scan table are set. The chain of events thus far constitutes a logical sequence as follows. All systems on the network have been notified that a specific input has transitioned. An expected reply is noted, and a timer has been set into motion.

There are now two possible scenarios. These scenarios correspond to two possible outcomes that are significant to the operation of the premises automation system. The first outcome is that one or more programs running on one or more processors on the network sends a reply that is designed to direct the unit which detected the input to handle the event. With the specific embodiments discussed thus far, this reply would most likely be an output command packet as illustrated in FIG. 7. Such a packet would initiate a change in an output, designed to communicate to premises-based apparatus to cause the event to be handled. With the particular embodiments of the invention described thus far, this packet would also clear the semaphore and may also clear the timer. This process would, in effect, consume the input event that occurred when the physical input transitioned. In the flowchart at FIG. 9, the response is received at step 906 and the semaphore is cleared at step 907. As just discussed, the timer might also be cleared at step 907.

The other possible outcome is that no process on the network deals with the event, either due to having no ability to deal with it, or due to a failure in the software, processor, or network. In this case, the timer times out at step 908. The controller or unit which is processing the event would then take a default action at step 909, if the semaphore was still set, as it would be in this example. The algorithm illustrated in FIG. 9 therefore enhances the reliability of a premises automation system, by allowing certain default actions to take place in the event of a failure. Using the specific embodiments of the invention previously discussed, the default action would be caused when a packet I/O unit made its next pass of the output scan table data structure. An entry would specify the unique input identifier associated with the input that transitioned, and would also specify the semaphore being set and the timer at zero to both be true in order to change an output. The timer and semaphore could both optionally be cleared at that time. Also note that the timer can serve as the semaphore. In such a case, the semaphore would be considered to be set to one state when the time reads zero, and to another state when the timer has a non-zero value.

It should be noted that the “default action” as described above can take many forms other than setting an output. It can include sending Email or other packets on the Internet. It can even be the sending of the original packet response again after a specified time interval, or the initializing or setting into motion of a process whereby the packet is re-sent or “retried” repeatedly at regular intervals. This process can continue until a reply is finally received or until a timer measuring some longer time prior times out. Another possibility would be to set a process into motion that continually “pings” the unresponsive device until it is determined that the device is available and can handle an event again.

Returning to the specific embodiments of the invention, it is important to note that there can be multiple processes on multiple platforms on the network exercising control. These processors can effect different actions depending on their function, for example security, lighting, or HVAC. Any of the processes may clear a semaphore bit. Because the processes are independent, changes can be made in the event driven response/reply without changing any other processes on the system. This type of distributed control greatly enhances the versatility, and upgradability of a premises automation system using the invention. It is important however for a person setting up a system based on the invention to account for possible negative affects of the independence of the various processors on the network. For example, one process or can turn a light on, while another turns the same light off. One of ordinary skill in the art can easily manage and take into account these potential conflict situations so that they do not cause problems.

The duration of a time out set as described in FIG. 9 can be adaptive. There could be another entry in an associated variable section of a scan table that stores the average time it takes for an external process to respond to the specified input change. A timer variable could then be intelligently and adaptively set. This would help ensure response times to events that would be acceptable to the average user of the automated premises.

The disclosed premises automation system not only continues to operate without intervention from control processors if necessary, but can do so with a reasonable degree of features and functionality. An installer can add programs on a variety of platforms to the network that add additional, enhanced, or new functionality. In effect, when these programs consume events, they override the base level of fallback programming in the I/O units. In addition, a variety of programs can be used to control the premises. In much the same way that a personal computer has special programs for word processing, financial analysis, web browsing, etc., a premises that is automated with the present invention can have specialty programs for different aspects of premises automation, and those programs can be executing on the same or different platforms or on the network, including the global Internet.

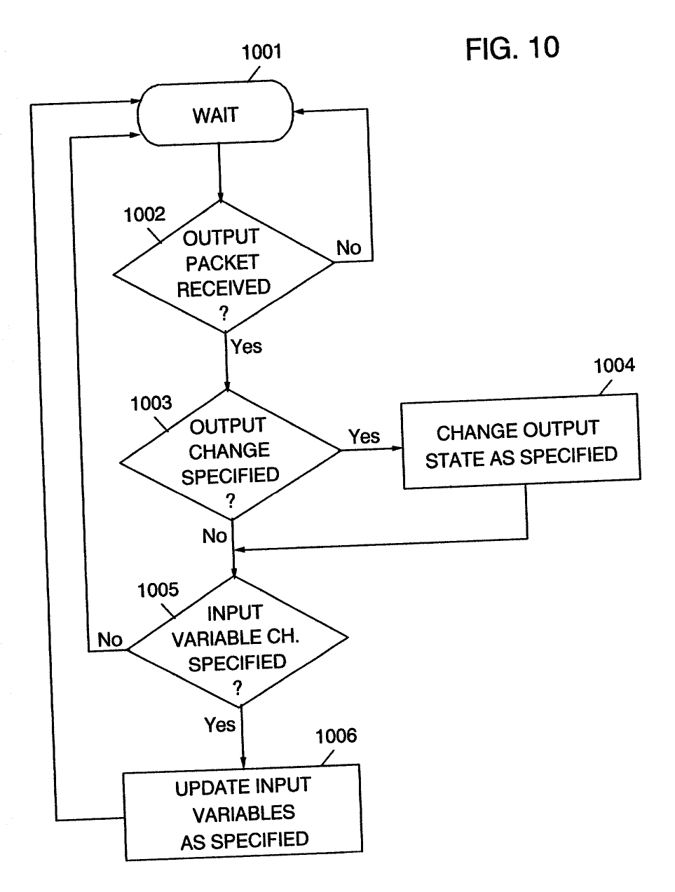

Turning to FIG. 10, a flowchart is shown which illustrates how an I/O unit in a premises automation system according to the invention responds to an output packet. At 1001 the unit is waiting for either an input change or a packet to be received over the network. At 1002 an output packet is received. At step 1003 the output packet is parsed, and a determination is made as to whether an output needs to be changed in response to the packet. An output may not need to be changed if, for example, the packet was only sent to effect a change in associated variables. At step 1004 the output state of the specified output is changed as specified. An output identifier corresponding to the output is present in the packet when received, and can be read by the I/O unit. The specific change in state required is also encoded in the packet. The output is set in accordance with the output identifier and the change of state indicated in the packet typically in order to communicate with premises based apparatus.

As previously discussed, an output packet like that shown in FIG. 7 can also direct changes to an internal variable or variables associated with an input. At step 1006 of FIG. 10, such a change is made if it is determined that such a change is specified in the packet at step 1005. In either case, the appropriate output to be changed, and the appropriate associated variables to be changed, are determined by the presence of the corresponding unique identifiers within the output packet.

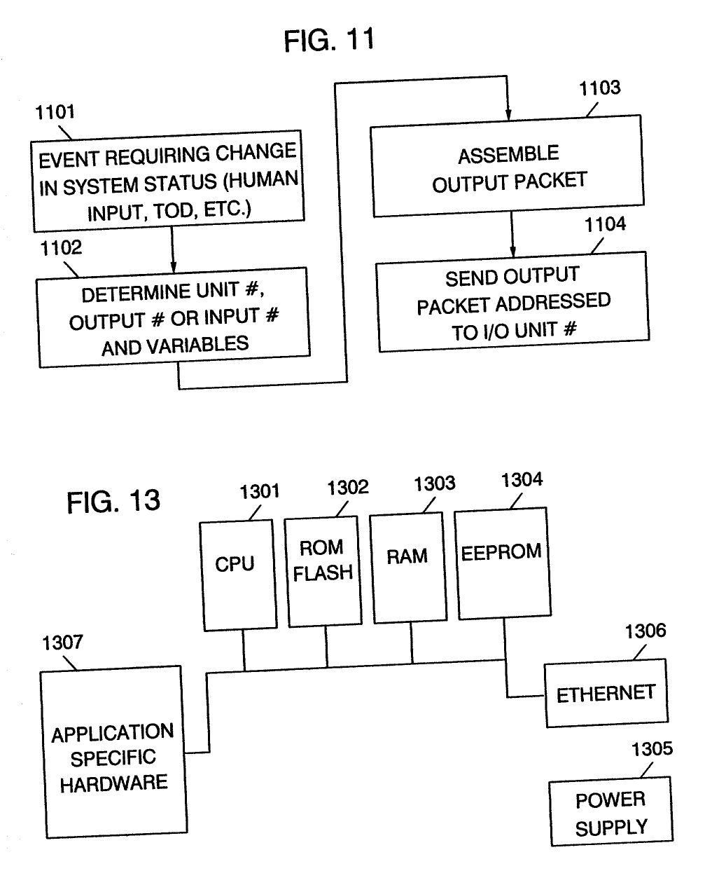

Of course, processor controlled apparatus which may be connected to the premises automation system can generate output packets to be sent to I/O units over the network. The processor controlled apparatus can be a home automation input device such as a keypad or infrared transmitter, or even a personal computer or work station connected to the premises automation system. In the latter case, the computer system of interest is running home automation software, which serves to direct the computer system to generate output packets as well as perform other functions related to premises automation. FIG. 11 illustrates a software flowchart for the output packet creation and sending process according to an embodiment of the invention. At step 1101, an event occurs which requires a change in the system status, such as a change in an output or the setting of a process in motion which involves manipulation or changes to internal variables in one of the I/O units. Often, such a change in status will be the result of human intervention, such as making an entry on a keypad, or selecting a particular function on a personal computer software application. The change might simply be that a certain time-of-day (TOD) has been reached. At step 1102 the apparatus which is to send the packet determines, most likely through the use of software or program code, which output needs to be changed and exactly what the change in state of the output should be. If associated variables at an input need to be changed, that determination is made also. As before, inputs and outputs are specified by their unique identifiers that are known to the software involved. At step 1103 the output packet is assembled, including the appropriate output identifier corresponding to the output which is to be changed and a description of the appropriate change in state. The optional associated variable change fields in the packet will be populated as necessary at this step. Finally, at step 1104 the output packet is sent over the network, addressed and formatted to direct the change of state as required. In many cases this change of state is designed to effect communication with premises based apparatus such as security systems, lighting systems, or HVAC controllers.

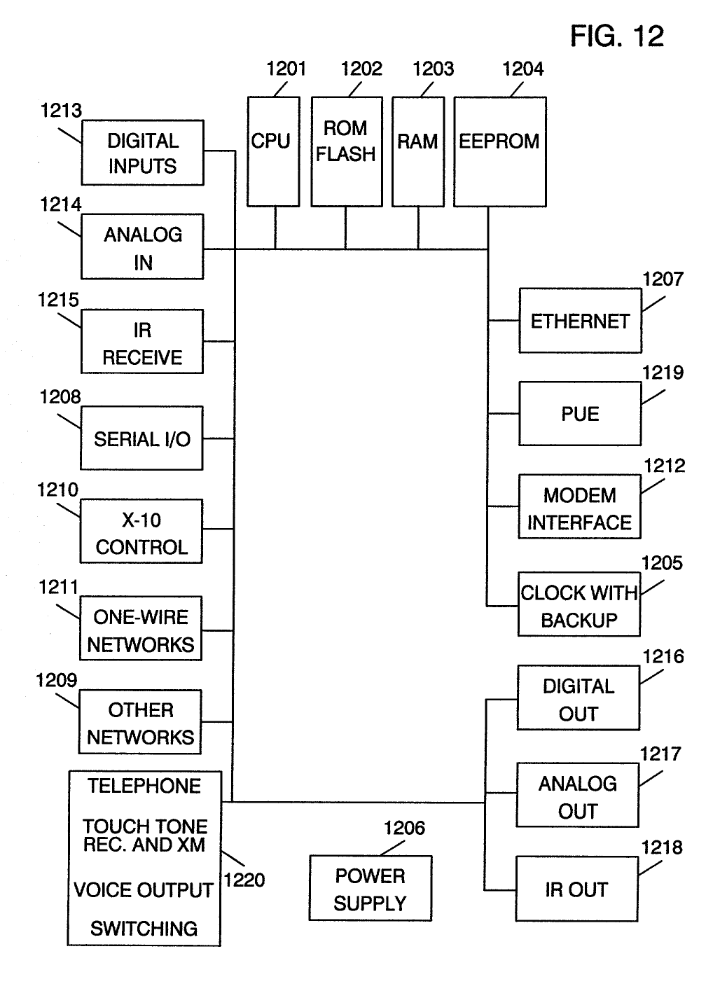

FIG. 12 is a hardware block diagram of an I/O unit according to one embodiment of the invention. FIG. 12, by way of example, shows the design of a packet I/O unit. However, a peripheral unit's design is similar, except possibly for reduced amounts of memory, inputs and outputs. A peripheral unit might also not have the telephone interface components and may not have an Ethernet interface, communicating instead solely through the PUE bus with its packet I/O unit. It cannot be over-emphasized that the hardware description shown here is shown as an illustrative example only. An I/O unit that implements the inventive concepts described herein can be built according to any of many possible hardware designs. Also, a system could be designed so that any particular interface unit contains only inputs, or only outputs. In either or each case, the inputs or outputs or both can still be addressed using a unique identifier systems discussed herein. The I/O unit of FIG. 12 includes a central processing unit (CPU), 1201, ROM or flash ROM memory 1202, RAM 1203, and non-volatile storage. In the example of FIG. 12, the non-volatile storage is an electrically erasable programmable read-only memory (EEPROM). The unit illustrated in FIG. 12 also includes a clock with a power backup system, 1205, and a power supply with an optional internal or external backup battery, 1206. The unit of FIG. 12 essentially consists of a processor system including the CPU and memory and a plurality of local inputs and outputs operatively connected to the processor. At least one network interface capable of communicating with internet protocol (IP) based equipment is desirable. In the example in FIG. 12, Ethernet interface, 1207, provides this function.

Special, bidirectional I/O interfaces include serial interface 1208, interface 1209 to specialized networks of the user's or implementer's choosing, and the interfaces to more traditional home automation type low level signaling networks, 1210 and 1211. Bi-directional I/O interfaces are treated as inputs within the unique identifier designation scheme of the invention in this embodiment. However, these could be treated as both inputs and outputs by applying a unique identifier to them for each function. A modem interface (dial-up, cable, DSL, etc.), 1212, can be optionally provided if Internet access is needed. The plurality of local inputs in the unit of FIG. 12 includes digital inputs 1213, analog inputs 1214, and infrared (IR) receivers 1215. The plurality of local outputs for the unit of FIG. 12 includes digital outputs 1216, analog outputs 1217, and an infrared transmitter or infrared output 1218.

Peripheral unit expansion bus interface 1219 is also shown. As previously discussed, the PUE bus runs a protocol that is used to communicate with other, usually smaller, peripheral I/O units. In this embodiment, the PUE bus runs on two pairs of conductors; a power pair and an RS-485 type communications pair. Sample rates of less than 60 hertz are generally adequate for this interface. The protocol for the PUE bus is half-duplex. Frames of information sent over the bus include source and destination addresses, length information, payload information, and check sums. The payload can be used to encapsulate data or packets from other parts of the system. For example the payload can be an output packet as described in FIG. 7. Frames of information exchanged on the PUE bus can also include a simple payload designed to directly control a very small microprocessor, which may be all that is required on some low function peripheral I/O units.

X10 interface 1210 is used to interface to an X10 system. X10 is a well-known system for controlling devices via a signal superimposed over existing 120 volt wiring. In this embodiment, the X10 interface can connect directly to a module that injects a carrier on the power line to implement X10 control. Software or hardware in the I/O unit can also derive a raw bit stream from X10 commands received over interface 1210.

Interface 1211 is used to connect to a family of devices manufactured and marketed by the Dallas Semiconductor Corporation known as 1-Wire™ devices. These devices use a signal wire carrying both power and signaling. Interface 1211 performs parallel to serial conversion and ensures correct timing of signals received from a 1-Wire system.

It is convenient to provide for the generation of multiple different voltages by power supply 1206. Power should be provided for relay drivers, audio circuits, and digital logic. The power supply is also designed to trickle charge a backup battery. The power supply in the embodiment of FIG. 12 also includes connections to an analog-to-digital (A/D) converter on the main microprocessor for the unit. The A/D converter is used to monitor for failures. The power supply also includes a temperature sensor that can be read by the CPU to ensure that the unit's power supply is not running too hot.

Connections for telephone equipment are provided by telephone interface 1220. The interface includes circuitry for detecting ringing, detecting an off-hook condition, effecting line pickup, reading dual tone multifrequency (DTMF) signaling, and routing baseband audio. The unit can also provide for caller-ID. When a call comes in, the ID of the caller can be reported on the network. Programs can be run on the network that can determine if the call should be allowed to ring inside the premises. This function could be used for call screening, or to provide a “do not disturb” function.

The digital inputs and outputs, 1213 and 1216 in FIG. 12, respectively, can each include multiple discrete inputs or outputs. Each input and output has two wires. One wire is ground, and the other is the signal. These inputs and outputs may include over voltage and reverse voltage protection, as well as filtering for radio frequency (RF) interference. Software processes inputs using user or installer provided information regarding transition rates. User or installer supplied information is also provided to dictate whether a digital output is connected to a relay. If a particular output is to be connected to a relay, there is a small mandatory delay imposed when switching occurs. This delay prevents excessive relay wear if the I/O unit attempts to switch the relay at an excessive rate due to a malfunction.

Analog inputs 1214 are addressable through the unique identifier system discussed. These inputs are connected to an A/D converter. The converter has twelve bits of resolution in this embodiment. The reference voltage is four volts. The reference voltage is measured at the time a unit is manufactured and entered into non-volatile memory. Software can then correct readings from the analog to digital converter in order to calibrate the unit. The analog inputs can be used for a variety of analog input data, including temperature measurements.

Analog outputs 1217 are connected to a digital-to-analog (D/A) converter which also has twelve bits of resolution in this embodiment. Among other things, the analog outputs can be used for the audio output of synthesized speech. Speech can be stored in the unit in a variety of file formats depending on the software. If personal computer “wave” files are employed, it is advantageous to store the speech in the I/O unit at approximately 1/4 of the audio compact disc rate, or 11.025 k samples per second. This allows speech to be digitally mixed in with CD audio.

Infrared (I/R) receive interface 1215 is designed to connect to standard infrared receivers. Infrared outputs 1218 can drive IR LED's directly. The IR outputs can be activated directly by software. These are also considered inputs and outputs that can be addressed by the unique identifier scheme previously discussed. Using IR capabilities, multiple units could be connected together and a virtual IR crosspoint switch could be created. A receiver or separate logic can be programmed to over-sample an IR bit stream received. This would allow the computation of the carrier frequency. Therefore, an I/O unit could determine the IR code it received and broadcast the code in a packet over the Ethernet to all other units. The other units could then determine if it was necessary to route the IR code to a specific output.

The memory in an I/O unit of the present embodiment is organized as follows. The flash memory, 1202, is used for the operating system, speech, field programmable gate array (FPGA) images, and scan table data structures. FPGA's are used to implement some of the functions of the unit in some embodiments. An “image” or program for an FPGA is loaded into the FPGA at power-up as part of a boot-up sequence. RAM 1203 is used for storing task information and buffer data. EEPROM 1204 stores system information, configuration information, and calibration data. The sizes of memory used in an I/O unit, even the packet I/O unit, are not required to be particularly large. Two megabytes of flash memory, 128 kilobytes of RAM, and 4 kilobytes of EEPROM has been found to be adequate. Of course, additional memory could be used to provide additional function and features. Initial routing tables using unit numbers can be stored in either EEPROM or flash memory. These can optionally be loaded into RAM after boot-up and modified by software for more current or complex routing.

FIG. 13 is a hardware block diagram of an example processor controlled apparatus for connection to a system including the I/O units described herein. This particular apparatus is enabled to send output packets into the system to exercise control over premises automation functions. The apparatus contains a processor or CPU, 1301. Storage devices, in this case various types of hardware memory, are included, and are operatively interfaced to the processor. The memory includes flash ROM 1302, RAM 1303, and EEPROM 1304. These memory devices perform a function for the apparatus of FIG. 13 similar to the function they provide for the packet I/O unit as discussed with reference to FIG. 12. Flash ROM 1302 typically stores programming information. RAM 1303 is used for buffering. EEPROM 1304 is used to store configuration and similar information. Power for the device is provided by power supply 1305. A network connection, 1306, is provided to communicate with the premises automation system. In this example, an Ethernet connection is provided.

Application specific hardware 1307 is provided. This hardware varies greatly depending on the particular function of the device. For example, if the device is a keypad entry unit for providing human input to the system, the application specific hardware might include a keypad, a liquid crystal display, and accompanying, supporting circuitry. It should be noted that the hardware platforms described herein can be combined with other, well known, traditional apparatus to produce intelligent devices for the home. For example, an I/O unit could be combined with an Ethernet hub. An I/O unit could also be combined with a home entertainment device such as a satellite receiver, cable box, audio/video server, database server, or a digital video recorder. Processor controlled apparatus like that shown in FIG. 13 could be combined with any of the above. It would also be particularly suitable to be combined with or included in a home appliance. A controller such as an HVAC controller or lighting controller can be combined with a peripheral I/O unit so that the inputs and outputs of the controller are effectively treated as distributed inputs and outputs of the premises automation system.

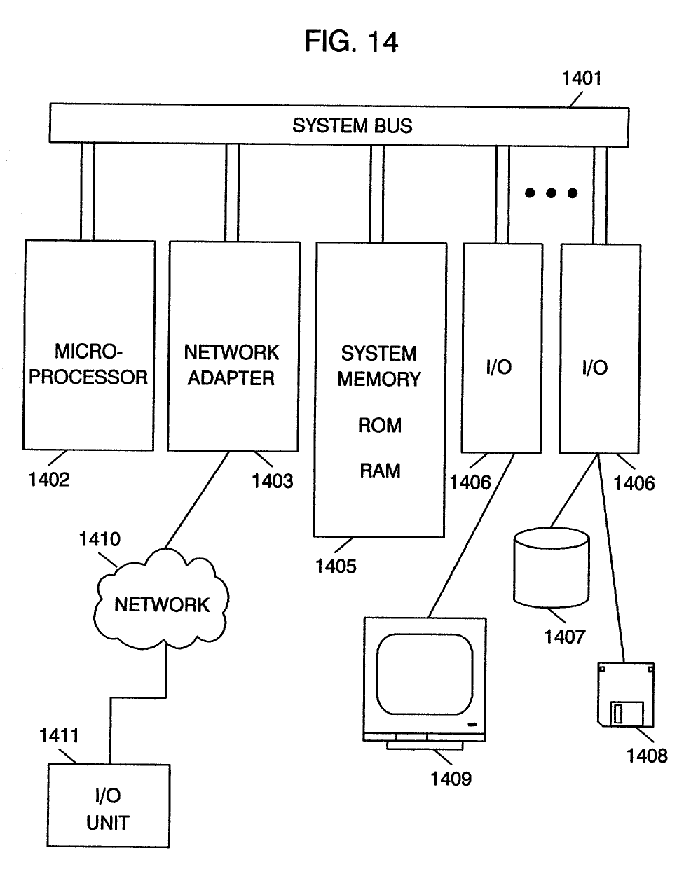

FIG. 14 illustrates another type of processor controlled apparatus that can interface with an I/O unit over a network to issue output packets and exercise other control over the system. FIG. 14 illustrates the detail of the computer system that is programmed with application software to implement these functions. System bus 1401 interconnects the major components. The system is controlled by microprocessor 1402, which serves as the central processing unit (CPU) for the system. System memory 1405 is typically divided into multiple types of memory or memory areas such as read-only memory (ROM), and random access memory (RAM). A plurality of general-purpose adapters or devices, 1406, is present. Only two are shown for clarity. These connect to various devices including a fixed disc drive, 1407, a diskette drive, 1408, and a display, 1409. Computer program code instructions for implementing the appropriate functions are stored on the fixed disc, 1407. When the system is operating, the instructions are partially loaded into memory, 1405, and executed by microprocessor 1402. An additional adapter device, network adapter 1403, connects to the premises network, 1410. The network in turn connects to one or more I/O units according to the invention, 1411. It should be noted that the system of FIG. 14 is meant as an illustrative example only. Numerous types of general purpose computer systems and workstations are available and can be used. Available systems include those that run operating systems such as Windows™ by Microsoft, various versions of UNIX™, various versions of Linux™, and various versions of Apple's Mac™ OS.

In any case, a computer program which implements parts of the invention through the use of a system like that illustrated in FIG. 14 can take the form of a computer program product residing on a computer usable or computer readable storage medium. Such a medium, a diskette, is illustrated graphically in FIG. 14 to represent the diskette drive. The medium may also be a stream of information being retrieved when the computer program product is “downloaded” through a network such as the Internet. Indeed, as previously discussed, many of the apparatus involved in carrying out the inventive concepts presented herein would rely in at least some embodiments on program code or microcode of some type. Any or all of this code can reside on any medium that can contain, store, communicate, propagate, or transport the program for use by or in connection with an instruction execution system, apparatus, or device. The computer-usable or computer-readable medium may be, for example but not limited to, an electronic, magnetic, optical, electromagnetic, infrared, or semiconductor system, apparatus, device, or propagation medium. Other examples of the computer-readable medium would include an electrical connection having one or more wires, a portable computer diskette or portable fixed disk, an optical fiber, a compact disc read-only memory (CD-ROM), and a digital versatile disc read-only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Specific embodiments of an invention are described herein. One of ordinary skill in the computing and networking arts will quickly recognize that the invention has other applications in other environments. In fact, many embodiments and implementations are possible. The following claims are in no way intended to limit the scope of the invention to the specific embodiments described above.

What is claimed is:

1. A machine readable memory encoded with a data structure for enabling a response to an input event in a packet-based premises automation system, the data structure comprising:
a plurality of input identifiers;
a plurality of input event descriptions associated with the plurality of input identifiers, wherein each input identifier has at least one associated event description; and
a plurality of action descriptions, at least one action description associated with each input event description.

2. The memory of claim 1 wherein at least one of the plurality of action descriptions causes a packet to be sent over a network in response to the input event.

3. The memory of claim 1 wherein at least one of the plurality of input identifiers refers to an internal input.

4. The memory of claim 1 wherein at least one of the plurality of input identifiers is of a format that can designate any of a plurality of distributed inputs.

5. The memory of claim 2 wherein at least one of the plurality of input identifiers is of a format that can designate any of a plurality of distributed inputs.

6. The memory of claim 3 wherein at least one of the plurality of input identifiers is of a format that can designate any of a plurality of distributed inputs.

7. A machine readable memory encoded with a data structure for providing a virtual input in a premises automation system, the data structure comprising:
a description of a logical relationship;
a plurality of entries to which the logical relationship applies, each entry producing a Boolean result on which the logical relationship operates to produce the virtual input, each entry further comprising:
at least a first input identifier serving as a first operand;
at least one operator; and
at least a second operand; and
a storage bit which corresponds to the virtual input.

8. The memory of claim 7 wherein the second operand in at least one of the plurality of entries is a second input identifier.

9. The memory of claim 7 wherein the second operand in at least one of the plurality of entries is a stored value.

10. The memory of claim 8 wherein the second operand in at least one of the plurality of entries is a stored value.

11. A method for providing a virtual input in a premises automation system, the method comprising:
producing a plurality of Boolean results, one Boolean result for each of a plurality of entries, each entry further comprising at least a first input identifier serving as a first operand, at least one operator, and at least a second operand;
applying a logical relationship to the plurality of Boolean results to produce the virtual input; and
setting a storage bit to correspond the virtual input.

12. The method of claim 11 wherein the second operand in at least one of the plurality of entries is a second input identifier.

13. The method of claim 11 wherein the second operand in at least one of the plurality of entries is a stored value.

14. The method of claim 12 wherein the second operand in at least one of the plurality of entries is a stored value.

15. Apparatus for providing a virtual input in a premises automation system, the apparatus comprising:
means for producing a plurality of Boolean results, one Boolean result for each of a plurality of entries, each entry further comprising at least a first input identifier serving as a first operand, at least one operator, and at least a second operand;
means for applying a logical relationship to the plurality of Boolean results to produce the virtual input; and
means for setting a storage bit corresponding to the virtual input.

16. A method of responding to an input event in a packet-based premises automation system, the method comprising:
detecting the input event by reference to a scan table stored in memory specifying the event in association with an input identifier;
performing an action based on a description of the action which is stored in the scan table in association with the input event and the input identifier;
determining if any internal variables need to be updated in conjunction with the action performed; and
updating at least one internal variable if the at least one internal variable needs to be updated.

17. The method of claim 16 wherein the input event is a change at an external input and wherein the action comprises the sending of a packet on a network wherein the packet is formatted to communicate the occurrence of the event.

18. The method of claim 16 wherein the input identifier is of a format that can designate any of a plurality of distributed inputs.

19. The method of claim 17 wherein the input identifier is of a format that can designate any of a plurality of distributed inputs.

20. Apparatus for responding to an input event in a packet-based premises automation system, the apparatus comprising:
means for detecting the input event by reference to a scan table stored in memory specifying the event in association with an input identifier;
means for performing an action based on a description of the action which is stored in the scan table in association with the input event and the input identifier; and
means for updating at least one internal variable in conjunction with performing the action.

21. The apparatus of claim 20 wherein the means for performing further comprises means for sending a packet on a network, the packet being formatted to communicate the occurrence of the event.

22. A method of responding to a premises-related event in a premises automation system, the method comprising:
detecting the premises-related event by reference to at least one data structure stored in memory specifying the premises-related event in association with an input identifier;
sending a packet over a network in response to the premises-related event, the packet being formatted to communicate the premises-related event;
if a reply to the packet is expected, a pre-determined time period has elapsed, and the reply has not been received, performing a default action specified in the at least one data structure.

23. The method of claim 22 wherein the at least one data structure comprises:
a first data structure including the input identifier associated with the event, wherein the input identifier is of a format that can designate any of a plurality of distributed inputs; and
a second data structure defining the default action.

24. The method of claim 22 wherein performing the default action further comprises setting an output.

25. The method of claim 23 wherein performing the default action further comprises setting an output, the output being described by an output identifier of a format that can designate any of a plurality of distributed outputs, the output identifier being stored in the second data structure in association with the default action.

26. Apparatus for responding to a premises-related event in a premises automation system, the apparatus comprising:
means for detecting the premises-related event in association with an input identifier;
means for sending a packet over a network in response to the premises-related event, the packet being formatted to communicate the premises-related event;
means for waiting a pre-determined time period during which a reply is expected;
means for performing a default action specified if the reply is not received during the pre-determined time period.

27. The apparatus of claim 26 further comprising:
a first data structure including the input identifier associated with the premises-related event; and
a second data structure defining the default action.

28. A method of setting an output in a premises automation system, the method comprising:
receiving a packet over a network, the packet formatted to direct a change in a state of the output, the output being interfaced to premises-based apparatus;
determining, at least in part from the packet, an output identifier corresponding to the output, as well as the change in the state; and
setting the output in accordance with the output identifier and the change in the state indicated in the packet in order to communicate with the premises-based apparatus.

29. The method of claim 28 wherein the packet is also formatted to direct a change in an internal variable associated with an input, and further comprising updating the internal variable in accordance with an input identifier in the packet.

30. The method of claim 28 wherein the output identifier is of a format that can designate any of a plurality of distributed outputs in the premises automation system.

31. The method of claim 29 wherein the output identifier is of a format that can designate any of a plurality of distributed outputs and the input identifier is of a format that can designate any of a plurality of distributed inputs in the premises automation system.

32. Apparatus for setting an output in a premises automation system, the apparatus comprising:
at least one output, the output operable to interface with premises-based apparatus;
means for receiving a packet over a network, the packet formatted to direct a change in a state of the output;
means for determining, at least in part from the packet, an output identifier corresponding to the output, as well as the change in the state; and
means for setting the output in accordance with the output identifier and the change in the state indicated in the packet in order to communicate with the premises-based apparatus.

33. The apparatus of claim 32 wherein the packet is also formatted to direct a change in an internal variable associated with an input, and further comprising means for updating the internal variable in accordance with an input identifier in the packet.

34. The apparatus of claim 32 wherein the output identifier is of a format that can designate any of a plurality of distributed outputs in the premises automation system.

35. The apparatus of claim 33 wherein the output identifier is of a format that can designate any of a plurality of distributed outputs and the input identifier is of a format that can designate any of a plurality of distributed inputs in the premises automation system.

36. An input/output (I/O) unit for use in premises automation, the input/output unit comprising:
a processor for controlling the operation of the I/O unit;
a plurality of inputs and outputs operatively connected to the processor, at least some of the inputs and outputs operable to communicate with premises-based apparatus;
a network connection; and
a memory connected to the processor, the memory encoded with program code to enable the processor to control the operation of the I/O unit to send a packet over the network connection in response to a premises-related event, the packet being formatted to communicate the premises-related event.

37. The I/O unit of claim 36 wherein the memory device is further encoded with program code that enables the I/O unit to wait for a pre-determined time period during which a reply to the packet is expected, and perform a default action if the reply is not received during the pre-determined time period.

38. The I/O unit of claim 37 wherein the memory device is further encoded with:
a first data structure including an input identifier associated with the premises-related event, wherein the input identifier is of a format that can designate any of a plurality of distributed inputs in a premises automation system with multiple I/O units; and
a second data structure defining the default action.

39. The I/O unit of claim 36 wherein the memory device is further encoded with program code to enable the I/O unit to receive an output packet formatted to direct a change in a state of a specific output and set the output in accordance with an output identifier and the change in the state specified in the output packet.

40. The I/O unit of claim 37 wherein the memory device is further encoded with program code to enable the I/O unit to receive an output packet formatted to direct a change in a state of a specific output and set the output in accordance with an output identifier and the change in the state specified in the output packet.

41. The I/O unit of claim 38 wherein the memory device is further encoded with program code to enable the I/O unit to receive an output packet formatted to direct a change in a state of a specific output and set the output in accordance with an output identifier and the change in the state specified in the output packet.

42. An input/output (I/O) unit for use in premises automation, the input/output unit comprising:
a processor for controlling the operation of the I/O unit;
a plurality of inputs and outputs operatively connected to the processor, at least some of the inputs and outputs operable to communicate with premises-based apparatus;
a network connection operable to communicate with the processor; and
a memory connected to the processor, the memory encoded with at least one data structure defining input events, and further encoded with program code to enable the processor to control the operation of the I/O unit to detect a specific input event by reference to the data structure and to perform an action associated with the input event.

43. The I/O unit of claim 42 wherein the input event is a change at a specific external input and wherein the action comprises the sending of a packet over the network connection and wherein the packet further comprises an input identifier corresponding to the input event which is of a format that can designate any of a plurality of distributed inputs in a premises automation system having multiple I/O units.

44. The I/O unit of claim 42 wherein the input event is a change in a specific internal input and wherein the action comprises the setting of a specific output in a premises automation system which can have multiple I/O units.

45. An input/output (I/O) unit for use in premises automation, the input/output unit comprising:
a processor for controlling the operation of the I/O unit;
a plurality of outputs operatively connected to the processor, at least some of the outputs operable to communicate with premises-based apparatus;
a network connection; and
a memory connected to the processor, the memory encoded with program code to enable the processor to control the operation of the I/O unit to receive, over the network connection, a packet formatted to direct a change in a state of a specific output that is operable to communicate with premises-based apparatus and set the specific output in accordance with an output identifier and the change in the state indicated in the packet in order to communicate with the premises-based apparatus.

46. The I/O unit of claim 45 wherein the wherein the output identifier is of a format that can designate any of a plurality of distributed outputs in a premises automation system containing multiple, interconnected I/O units.

47. The I/O unit of claim 45 wherein the packet also comprises an input identifier and is further formatted to direct a change in a variable associated with a specific input corresponding to the input identifier.

48. The I/O unit of claim 46 wherein the packet also comprises an input identifier and is further formatted to direct a change in a variable associated with a specific input corresponding to the input identifier, and further wherein the input identifier is of a format that can designate any of a plurality of distributed inputs in a premises automation system including multiple, interconnected I/O units.

49. A method of controlling an output in a premises automation system, the method comprising:
determining the output and that the output needs to change state in order to communicate with premises-based apparatus;
assembling a packet including an output identifier corresponding to the output, as well as the change in the state, wherein the output identifier is of a format that can specify any of a plurality of distributed outputs in the premises automation system; and
sending the packet over a network, the packet formatted to direct the change in the state of the output to communicate with the premises-based apparatus.

50. The method of claim 49 further comprising determining that a variable associated with an input needs to change state, and wherein assembling the packet further comprises the inclusion of an input identifier in the packet, wherein the input identifier is of a format that can specify any of a plurality of distributed inputs in the premises automation system.

51. Apparatus for controlling an output in a premises automation system, the method comprising:
means for determining the output and that the output needs to change state in order to communicate with premises-based apparatus;
means for assembling a packet including an output identifier corresponding to the output, as well as the change in the state, wherein the output identifier is of a format that can specify any of a plurality of distributed outputs in the premises automation system; and
means for sending the packet over a network, the packet formatted to direct the change in the state of the output to communicate with the premises-based apparatus.

52. The apparatus of claim 51 further comprising:
means for determining that a variable associated with an input needs to change state; and
means for inclusion in the packet of an input identifier, wherein the input identifier is of a format that can specify any of a plurality of distributed inputs in the premises automation system.

53 A computer program product for enabling a computer system to control an output in a premises automation system, the computer program product including a computer program comprising:
instructions for determining the output and that the output needs to change state in order to communicate with premises-based apparatus;
instructions for assembling a packet including an output identifier corresponding to the output, as well as the change in the state, wherein the output identifier is of a format that can specify any of a plurality of distributed outputs in the premises automation system; and
instructions for sending the packet over a network, the packet formatted to direct the change in the state of the output to communicate with the premises-based apparatus.

54 The computer program product of claim 53 wherein the computer program further comprises:
instructions for determining that a variable associated with an input needs to change state; and
instructions for inclusion in the packet of an input identifier, wherein the input identifier is of a format that can specify any of a plurality of distributed inputs in the premises automation system.

55. Processor-controlled apparatus for connection to a premises automation system, the processor-controlled apparatus comprising:
a processor for controlling the operation of the apparatus;
a network connection;
at least one storage device operatively connected to the processor, the at least one storage device including program code to direct the processor-controlled apparatus to determine that an output needs to change state, to assemble and send over the network connection a packet including an output identifier corresponding to the output, as well as the change in the state, wherein the output identifier is of a format that can specify any of a plurality of distributed outputs in the premises automation system.

56. The processor controlled apparatus of claim 55 wherein the packet further comprises an input identifier corresponding to an input for which associated variables are to be updated, and further wherein the input identifier is of a format that can specify any of a plurality of distributed inputs in the premises automation system.

57. An input/output (I/O) unit for use in premises automation, the input/output unit comprising:
a processor for controlling the operation of the I/O unit;
a plurality of inputs operatively connected to the processor, at least some of the inputs operable receive communication from premises-based apparatus; and
a memory connected to the processor, the memory encoded with program code to enable the processor to control the operation of the I/O unit to provide virtual inputs through a data structure further comprising:
a description of a logical relationship;
a plurality of entries to which the logical relationship applies, each entry producing a Boolean result on which the logical relationship operates to produce the virtual input, each entry further comprising:
at least a first input identifier serving as a first operand;
at least one operator; and
at least a second operand; and
a storage bit which corresponds to the virtual input.

58. The I/O unit of claim 57 wherein the second operand in at least one of the plurality of entries is a second input identifier.

59. The I/O unit of claim 57 wherein the second operand in at least one of the plurality of entries is a stored value.

60. The I/O unit of claim 58 wherein the second operand in at least one of the plurality of entries is a stored value.

61. An input/output (I/O) unit for use in premises automation, the input/output unit comprising:
a processor for controlling the operation of the I/O unit;
a plurality of inputs operatively connected to the processor, at least some of the inputs operable to receive communication from premises-based apparatus; and
a memory connected to the processor, the memory encoded with program code to enable the processor to control the operation of the I/O unit to provide virtual inputs by producing a plurality of Boolean results, one Boolean result for each of a plurality of entries, each entry further comprising at least a first input identifier and applying a logical relationship to the plurality of Boolean results to produce the virtual input.

62. The I/O unit of claim 61 wherein at least one of the plurality of entries further comprises a second input identifier.

63. The I/O unit of claim 61 wherein at least one of the plurality of entries further comprises a stored value.

64. The I/O unit of claim 62 wherein at least one of the plurality of entries further comprises a stored value.
